(19) United States
(12) Patent Application Publication
(10) Pub. No.: US 2010/0300804 A1
(43) Pub. Date: Dec. 2, 2010

(54) Di-Electric Harness For Fall Arrest Systems

(75) Inventor: Mark Willingham, Houston, TX (US)

Correspondence Address: CONLEY ROSE, P.C.;David A. Rose, P. O. BOX 3267, HOUSTON, TX, 77253-3267, US

(73) Assignee: WEB DEVICES, LLC, Houston, TX (US)

(21) Appl. No.: 12/787,692

(22) Filed: May 26, 2010

Related U.S. Application Data
(60) Provisional application No. 61/181,824, filed on May 28, 2009.

(51) Int. Cl. A62B 35/00

(52) U.S. Cl. 182/3

(57) ABSTRACT

The di-electric harness for fall arrest systems includes a full body harness having first and second webbings extending through a chest plate and back plate. The first and second webbings cross at the chest plate and at the back plate and form a loop at the back plate in which is disposed a D-ring. The first and second webbings each extend through a hip plate to form a leg strap. The chest plate, back plate and hip plates are made of non-metal.

### CROSS-REFERENCE TO RELATED APPLICATIONS

The present application claims the benefit of 35 U.S.C. 111(b) provisional application Serial No. 61/181,824 filed May 28, 2009, and entitled Di-Electric Harness for Fall Arrest Systems.

### STATEMENT REGARDING FEDERALLY SPONSORED RESEARCH OR DEVELOPMENT

Not-Applicable

### BACKGROUND OF THE INVENTION

Safety harnesses are widely used as primary components in fall protection systems for persons subjected to potential harm from sudden changes in elevation. Fall protection systems are defined as any assembly of components and subsystems, including necessary connectors, used to arrest the user in the event of a fall and suspend the user until proper rescue. In elevated working environments, safety harnesses of the full-body type are generally used. These types of harnesses ensure necessary suspension and support, both in expected or unexpected changes in elevation. In addition to elevated work environments, these harnesses are typically used for work positioning, travel restriction, ladder climbing, rescue retrieval and evacuation. One such example of a well-known full-body type harness is the “H” type harness. The “H” type harness, however, has proven to be known for slippage and being less secure. A wearer has been known to slip out of the “H” type harness. Although full-body harnesses are appreciated for application in industrial settings, such as the construction industry where the likelihood and danger of falls from elevated locations are both numerous and critical, full-body harnesses may still be insufficient in preventing all consequential injury from sudden changes in elevation.

Full body harnesses are generally designed with straps to fasten around the user in order to distribute fall arrest forces over at least the upper thighs, pelvis, chest and shoulders. This moves the impact of a fall from the internal organs to the major bone and muscle groups around the pelvis. The full body harness includes a means for attaching to the other components of a fall arrest system. Every harness must have a fall arrest point, normally located on the back positioned between the shoulder blades. The fall arrest point is known in the art as being the area where a fall arrest system can connect to the harness, normally by using a lanyard of some type.

Harnesses are expected to meet strict OSHA (Occupational Safety and Health Administration), ANSI (American National Standards Institute) and CSA (Canadian Standards Association) standards, of which include 5,000 lbs. (22 kN) of minimum breaking strength at all attachment points and load bearing straps. To meet these standards, the fasteners on the harness have been made of metal. Metal fasteners have the strength to meet these standards as opposed to other types of non-metal fasteners. Generally, a D-ring loop design of PVC coated metal hardware is used for maximizing strength of the fall arrest system as well as to offer additional resistance to conductivity and sparking when working in certain industrial settings. Other types of metal connectors, e.g. clips, fasteners, buckles, etc., are used for securing the harness' fall arrest point to the fall arrest system. However, there has been no solution to the additional weightiness or electric potential that still exists in these designs, which generally include any various metal type hardware. The metal rings and connectors on the harness tend to conduct electricity when they engage an electrical component near the wearer. Some harnesses provide an insulating coating on the metal rings and fasteners but these have been proven not to be fully effective. The electric potential, or arc flash, may still increase exponentially in certain applications as various coated metal hardware designs can only finitely protect against static build-up. Needless to say, a harness' metal constituency and webbing may affect static build-up, even when, for example, a PVC coating is used as an insulating means around said metal constituency, or component. Another well-known option in the fall arrest art for decreasing the potential hazardous nature of conductive type materials, in addition to the application of a PVC coating, includes regulating arc flash with leather type insulators.

The more recently available full-body safety type harnesses are, more often than not, manufactured from flexible, however relatively inelastic, woven materials such as nylon and polyester. However, arc flash standards have given rise to nylon or Nomex®/Kevlar® materials being standardly used to meet the requirements of utility work in industrial applications where electrical, or transformer, work may be performed. Still, the usage of conductive type materials such as buckles, fasteners, clips, etc. with these more recently available harnesses still expose users to potentially hazardous conditions.

It should be appreciated that the metal used on the harness adds substantial weight. This is detrimental to the wearer wearing the harness for long periods of time. Thus there is a need for a lighter weight harness that can be worn by the wearer throughout the working day.

Work in remote electrically hazardous locations requires fall protection to be lightweight, portable and very compact. With over 100,000 incidents reported yearly, falls from elevated heights normally result in extremely serious injury, if not death. Therefore, it is desirable to simplify construction of harnesses without reducing quality and increasing durability and versatility. It is further desirable to have a harness completely free of any conductor type materials and of substantially lightweight construction.

Other objects and advantages of the invention will appear from the following description.

### BRIEF DESCRIPTION OF THE DRAWINGS

For a detailed description of a preferred embodiment of the invention, reference will now be made to the accompanying drawings wherein:

FIG. 1 is a front view of the full body harness as it would be worn by a user;

FIG. 2 is a rear view of the full body harness as it would be worn by a user;

FIG. 3 is a plan view of the chest and back plates; and

FIG. 4 is a plan view of a hip plate.

### DETAILED DESCRIPTION OF PREFERRED EMBODIMENTS

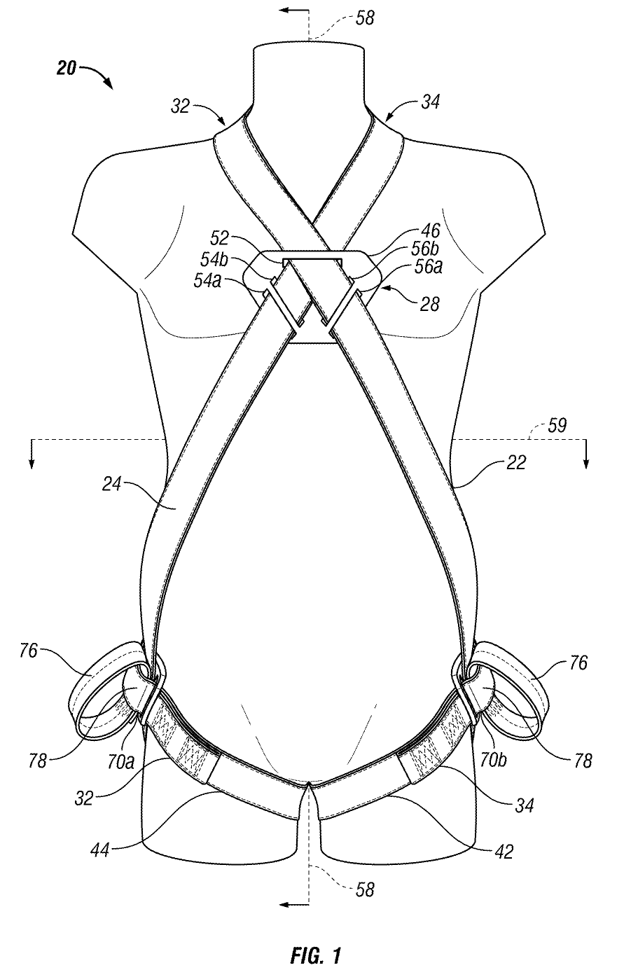

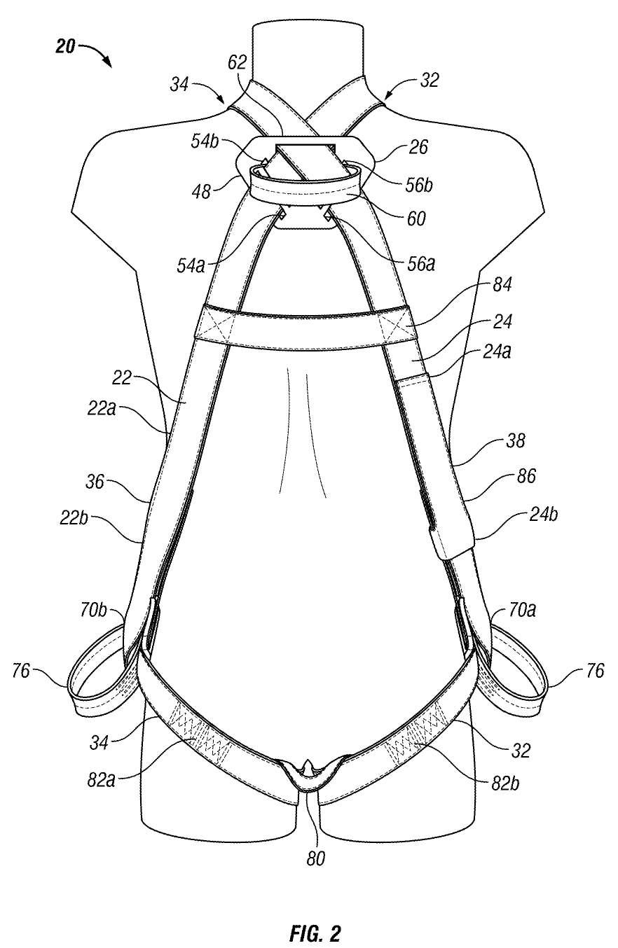

The following discussion is directed to various embodiments of the invention, defined initially and referred to in FIGS. 1-2. Although one or more of these embodiments may be preferred, the embodiments disclosed should not be interpreted, or otherwise used, as limiting the scope of the disclosure. In addition, one skilled in the art will understand that the following description has broad application, and the discussion of any embodiment is meant only to be exemplary of that embodiment.

Referring now to FIGS. 1 and 2, FIG. 1 shows a front view of harness 20 and FIG. 2 shows a back view of harness 20. Harness 20 is a harness of the full-body pull-over type. Preferably, Harness 20 is a cross-over or “X” type harness composed of webbing of the High Performance or standard type, crossing over in the mid-chest area and upper dorsal, or back area. Harness 20 consists of webbing and plastic type materials, i.e., non-metallic materials, thereby becoming substantially non-conductive with respect to electric arc flash. Harness 20 is formed by two pieces of webbing 22, 24 having a finite length, L, crossing each other at back plate 26 and chest plate 28. Each webbing 22, 24 has two distinct ends 22a, 22b and 24a, 24b, and forms shoulder straps 32, 34 and leg straps 42, 44, respectively. Shoulder strap 32 is situated to rest upon the user's right shoulder and wrap around toward a left hip area, while shoulder strap 34 rests upon the user's left shoulder and wraps around toward a right hip area. Each distinct end 22a, 22b of webbing 22 is adjoined at an end area 36 along the hip area of the user. Webbing 24 is adjoined in a similar fashion at 38. A box-type stitching is the preferable adjoining means. Although not preferred, Velcro may be used as the adjoining means. Other types of adjoining means will become readily apparent upon further understanding of alternate embodiments disclosed herein.

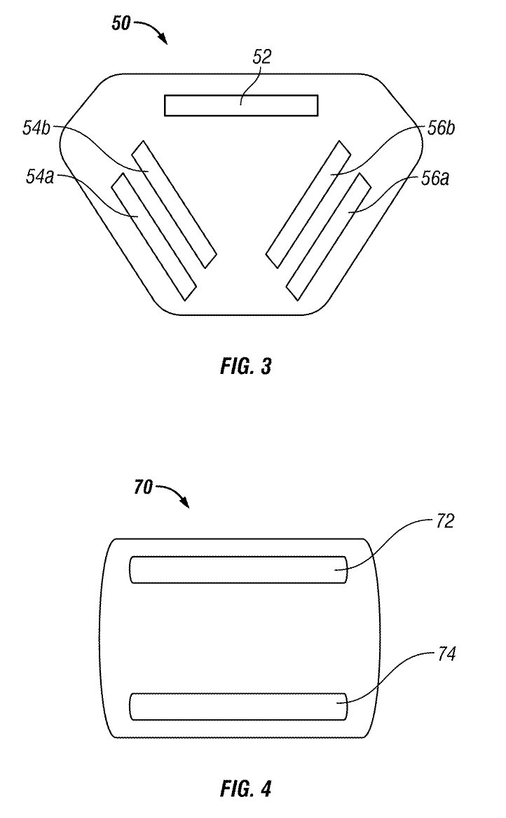

Referring now to FIG. 3, there is shown a plate 50 that is used both for the chest plate 46 and back plate 48. Plate 50 has a body that includes a generally horizontal web slot 52 in the central upper part of the body and a first set of angled and parallel web slots 54a, 54b on one side of the body and a second set of angled and parallel web slots 56a, 56b on the other side of the body. The angled web slots have an angle that comports with the angle of the webbing 22, 24 as they cross the user's body. The opening in slot 52 extends substantially perpendicular to a longitudinal axis 58 of the user and is of higher positioning relative to the other slot openings 54, 56 with respect to horizontal 59. The two slot openings 54, 56 of chest plate 50 extend transversely to the longitudinal axis 58. Slots 52, 54a, 54b and 56a, 56b receive the webbing 22, 24 as hereinafter described.

During assembly and prior to the adjoining of each distinct end 22a, 22b and 24a, 24b of webbings 22, 24, one of the ends 22a, 22b of webbing 22 is inserted into web slot 56a toward the user and then back out of web slot 56b of chest plate 46. The web end is then passed through slot 52 toward the user. The other end of webbing 22 is then inserted into the web slot opening 52 of back plate 48 and through a D-ring hereinafter described. The webbing 22 is then inserted into web slot 54a of the back plate 48 toward the user and then back out of web slot 54b away from the user. Now one of the ends 24a, 24b of webbing 24 is inserted into web slot 54a toward the user and then back out of web slot 54b of chest plate 46. The web end is then passed through slot 52 toward the user, overlapping webbing 22 in a crossing manner transverse to the axis 58, 59. The end of webbing 24 is then inserted into the web slot opening 52 of back plate 48 and through a D-ring 60 hereinafter described, again overlapping webbing 22 and forming an external loop 62 in which is disposed D-ring 60. The webbing 22 is then inserted into web slot 56a of the back plate 48 toward the user and then back out of web slot 56b away from the user. The slots are preferably wide enough to permit the webbing to pass through the web slots and allow adjustment of webbings 22, 24 while being narrow enough to grip the webbing 22, 24 and prevent slippage.

The dorsal D-ring 60 is attached to back plate 48 by webbing loop 62. Dorsal D-ring 60 is configured to rest upon back plate 62, therebetween plate 60 and webbing 22, 24. In some embodiments, another D-ring similar to dorsal D-ring 60 may be used with chest plate 46. Preferably, dorsal D-ring 60 is situated on back plate 48 in a fashion conducive to being adjustable, between plate 48 and webbing 22, 24. Dorsal D-ring 60, in some preferred embodiments, also has a polyurethane type covering.

Referring now to FIG. 4, there is shown a hip plate 70 having a body with first and second web slots 72, 74. The two web slots 72, 74 have parallel orientation to a central horizontal axis of the hip plate 70. Hip plate 70 is used both for the right hip plate 70a and left hip plate 70b. After webbing 22, 24 is threaded through the web slot openings of chest plate 46 and back plate 48, the ends of webbing 22, 24 are then inserted into right and left hip plate 70a, 70b. The end of webbing 22 is inserted into lower web slot 74 of left hip plate 70b away from the user to form an external loop 78 passing through a tool ring 76, hereinafter described, and over webbing 22 (through which webbing 22 passes), as it is then inserted into upper web slot 72 toward the user. The webbing 22 is sewn on each side of the right hip plate 70a to help maintain its position. Likewise, the end of webbing 24 is inserted into lower web slot 74 of left hip plate 70b away from the user to form an external loop 78 passing through a tool ring 76, hereinafter described, and over webbing 24 (through which webbing 24 passes), as it is then inserted into upper web slot 72 toward the user. The webbing 22 is sewn on each side of the left hip plate 70b to help maintain its position.

Preferably, tool ring 76 rests upon a portion of threaded webbing 22, 24, at least 25% of the hip plate 70, while being secured by yet another threaded portion of webbing 22, 24. Tool ring 76 is used for carrying additional items, e.g. tools, appliances, connectors, etc and may comprise a polyurethane type covering, or any other suitable plastic type covering. Additionally, hip plate 70 serves as an adjustment point for the leg strap 32, 34. The only adjustment of harness 20 occurs at the plates 46, 48, and 70. More specifically, the user can adjust the length of webbing 22, 24 to a preferred size fitting through the adjustment of the chest plate 46, back plate 48 and hip plates 70a, 70b. In light of this, sizing is relative to the height and weight of the user.

A pelvic support strap 80 is connected to leg straps 32, 34 at connector zones 82a, 82b. The pelvic support strap 80 provides additional support, security and comfort for the user. While connector zones may have various adjoining means, it is preferable to use a double-box type stitching to provide maximum strength and durability. When leg straps 32, 34 are being adjusted, each strap adjusts in a slidably engaging manner with a portion of threaded webbing, thereby increasing or decreasing the circumference of the leg strap area. This allows users having larger or smaller leg circumference sizing to fit within leg straps 32, 34 without having to releasably adjust any mechanisms or fixtures, e.g. coated metal hardware structure(s) such as buckles, clips, fasteners, etc. The leg straps are free of any metal or conductive type materials. Harness 20, therefore, is completely free of any metal or conductive type materials.

In other embodiments, an additional support strap 84 may be added to maximize strength and durability of webbings 22, 24. The support strap may better distribute fall arrest forces towards the pelvis, hip and shoulder areas. Additionally, a cover 86 is used to protect the product and inspection information. Generally, the product and inspection information displays sizing, operating instructions, inspection log, warning labels, and any compliance information. Cover 86 is provided to protect this information in the need of promoting safe inspection, compliance and safety. Cover 86 is coupled to webbing 22 with a fastener means, e.g. Velcro, stitching, etc.

As can be seen from the above description, the harness 20 has no releasable fasteners of any type. Only plates 46, 48 , 70a, and 70b are provided. Thus, unlike the prior art, there are no fasteners or connectors to be undone for a user to get into the harness 20. In harness 20, the user first steps into the loops formed by the leg straps 32, 34 by stepping into harness 20 from the back between webbing 22, 24. The user then inserts his head between webbing 22, 24 between chest plate 46 and back plate 48. As previously described, the webbing 22, 24 can then be adjusted at plates 46, 48 , 70a, and 70b.

Although the present invention has been described in detail above for the purpose of illustration, it is to be clearly understood that such detail is solely for that purpose and that variations can be made therein by those skilled in the art without departing from the scope and spirit of embodiments disclosed herein.

We claim:

1. A full body harness comprising:
first and second webbings extending through a chest plate and a back plate, the first and second webbing crossing at the chest plate and at the back plate;
the first and second webbings forming a loop at the back plate in which is disposed a D-ring;
the first and second webbings each extending through a hip plate to form a leg strap; and
the chest plate, back plate and hip plates being made of non-metal.

2. The harness of claim 1 wherein the chest plate and back plate are each one piece and are not releasable connections

3. The harness of claim 1 wherein the first and second webbings are each made of a single length of webbing.

4. The harness of claim 1 wherein the D-ring is made of non-metal.

5. The harness of claim 1 wherein each webbing forms a loop at the hip plate for attaching a tool ring.
